(19) United States
(12) Patent Application Publication
(10) Pub. No.: US 2025/0363690 A1
(43) Pub. Date: Nov. 27, 2025

(54) DIFFUSION MODEL FOR OBJECT DRAGGING IN IMAGES

(71) Applicant: NVIDIA Corporation, Santa Clara, CA (US)

(72) Inventors: Omri Avrahami, Shoham (IL); Weili Nie, Sunnyvale, CA (US); Rinon Gal, Tel Aviv (IL); Arash Vahdat, San Mateo, CA (US); Gal Chechik, Ramat Hasharon (IL)

(21) Appl. No.: 19/066,010

(22) Filed: Feb. 27, 2025

Related U.S. Application Data
(60) Provisional application No. 63/650,331, filed on May 21, 2024.

(51) Int. Cl. G06T 11/60; G06T 5/70; G06T 7/11

(52) U.S. Cl. CPC G06T 11/60; G06T 5/70; G06T 7/11

(57) ABSTRACT

Seamlessly moving, or dragging, an object from one location in an image to another location in the image is, in practice, a challenge especially for current generative image editing methods. Current methods that tackle this problem rely on time-consuming Low Ranked Adaptation (LoRA) training per image, training a designated model on a large dataset or utilizing classifier-free guidance (CFG) with specific objectives. However, these methods are not robust and struggle to operate reliably in a real-world setting due to lacking spatial reasoning. The present disclosure provides a diffusion model that can harness spatial understanding when relocating an object in an image, thereby resulting in a more seamless result (e.g. fewer visual artifacts).

### CLAIM OF PRIORITY

This application claims the benefit of U.S. Provisional Application No. 63/650,331 (Attorney Docket No. NVIDP1404+/24-SC-0495US01) titled “TEXT-TO-IMAGE GENERATION MODEL FOR OBJECT DRAGGING,” filed May 21, 2024, the entire contents of which is incorporated herein by reference.

### TECHNICAL FIELD

The present disclosure relates to processes for relocating objects in an image.

### BACKGROUND

Digital image editing is widely used by both novice and expert users alike, and generally involves changing one or more existing features of a digital image. While some editing tasks may involve simplistic changes such as changing colors or blurring backgrounds, other editing tasks can be more difficult to achieve. For example, the conceptually simple task of seamlessly moving, or dragging, an object from one location in an image to another location in the image is, in practice, a challenge especially for current generative image editing methods.

Current methods that tackle this problem rely on time-consuming Low Ranked Adaptation (LoRA) training per image, training a designated model on a large dataset or utilizing classifier-free guidance (CFG) with specific objectives. However, these methods are not robust and struggle to operate reliably in a real-world setting due to lacking spatial reasoning. For example, existing methods generally suffer from artifacts leftover when moving an object from one location to another.

There is a need for addressing these issues and/or other issues associated with the prior art. For example, there is a need for a diffusion model that can harness spatial understanding when relocating an object in an image.

### SUMMARY

A method, computer readable medium, and system are disclosed to relocate an object in an image using a diffusion model. An input is obtained which specifies a relocation of an object existing in an image from an original location in the image to a new location in the image. A first primitive-based representation is generated for the image having the object at the original location and a second primitive-based representation is generated for the image having the object at the new location. A diffusion model is conditioned on the first primitive-based representation for the image and the second primitive-based representation for the image to generate a new image with the object at the new location.

### BRIEF DESCRIPTION OF THE DRAWINGS

FIG. 1 illustrates a flowchart of a method to relocate an object in an image using a diffusion model, in accordance with an embodiment.

FIG. 2A illustrates a neural network architecture configured to relocate an object in an image, in accordance with an embodiment.

FIG. 2B illustrates a pipeline of the neural network architecture of FIG. 2A, in accordance with an embodiment.

FIG. 3 illustrates a self-attention soft anchoring mechanism used by the neural network architecture of FIG. 2A, in accordance with an embodiment.

FIG. 4 illustrates an exemplary input and output of the method of FIG. 1, in accordance with an embodiment.

FIG. 5A illustrates inference and/or training logic, according to at least one embodiment.

FIG. 5B illustrates inference and/or training logic, according to at least one embodiment.

FIG. 6 illustrates training and deployment of a neural network, according to at least one embodiment.

FIG. 7 illustrates an example data center system, according to at least one embodiment.

### DETAILED DESCRIPTION

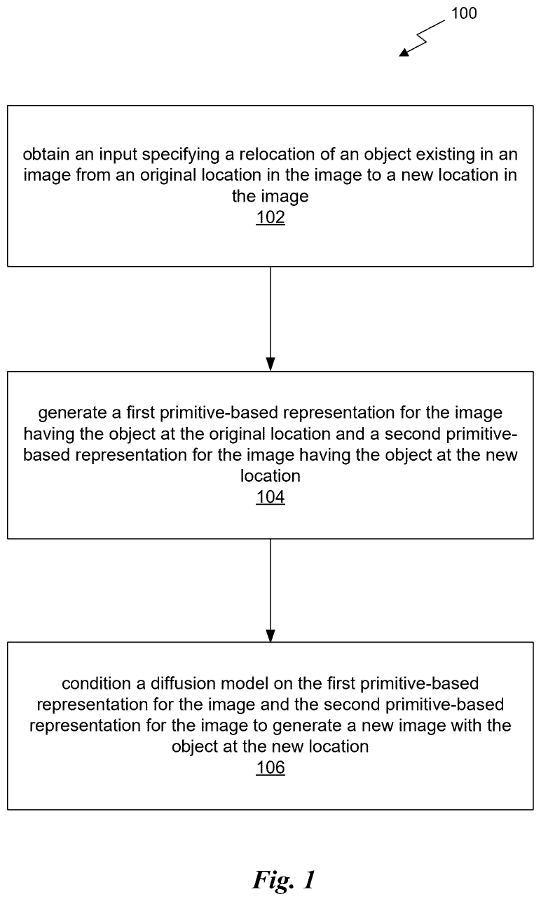

FIG. 1 illustrates a flowchart of a method 100 to relocate an object in an image using a diffusion model, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input is obtained which specifies a relocation of an object existing in an image from an original location in the image to a new location in the image. The image refers to any digital image depicting at least one object in a scene. In an embodiment, the image may be a synthetically generated image, such as for example an image generated using artificial intelligence (e.g. a generative diffusion model). In another embodiment, the image may be a real-world image (e.g. captured using a digital camera).

The input refers to data in any format that specifies at least the original (e.g. existing, current, etc.) location of the object in the image and the new (e.g. updated) location in the image to which the object is to be relocated. For example, the original and/or new locations may be specified by coordinates within the image. As another example, the original and/or new locations may be specified by an image mask, etc.

With respect to the present description, the new location is different in at least one respect from the original location. For example the new location may be shifted up, down, left, and/or right form the original location within the image. The new location may be at least partially comprised of different pixels of the image than the original location. In an embodiment, the new location may be represented with different coordinates in the image from the original location.

In an embodiment, the input may be generated by a user. In an embodiment, the user may generate the input using an image editing tool (i.e. software application) that allows the user to select an object at its original location in the image, or otherwise define a region in the image representative of the object at its original location in the image, and to further select the new location in the image to which the object is to be relocated, or otherwise define another region in the image representative of the new location in the image for the object. In an embodiment, the input may be obtained by the user dragging the object existing in the image from the original location in the image to the new location in the image (e.g. via the image editing tool). In these embodiments the input may be directly generated by the user, or generated by a computer process as a result of the actions taken by the user with respect to the image, for example using the image editing tool (e.g. to select the original and new locations, to drag the object from the original location to the new location, etc.).

In operation 104, a first primitive-based representation is generated for the image having the object at the original location and a second primitive-based representation is generated for the image having the object at the new location. A primitive-based representation refers to a representation of the image that is defined using at least one primitive (e.g. geometric shape). In an embodiment, the first primitive-based representation and the second primitive-based representation may be blob representations.

In an embodiment, the first primitive-based representation may include a first set of parameters defining a layout of the image having the object at the original location. Likewise, in an embodiment, the second primitive-based representation may include a second set of parameters defining a layout of the image having the object at the new location. The parameters may be blob parameters, in an embodiment.

In an embodiment, the first primitive-based representation and the second primitive-based representation may be generated using a segmentation model. In an embodiment, the segmentation model may generate a segmentation map from an input image, and a primitive optimization may be performed to find the best-fitting ellipse for the segmentation map to generate a primitive-based representation for the input image.

In an embodiment, the first primitive-based representation and the second primitive-based representation may also include respective text descriptions. In an embodiment, the respective text descriptions may be generated using a machine learning model. In an embodiment, the machine learning model may be configured to process a cropped region surrounding an object to generate a text description for the object.

In operation 106, a diffusion model is conditioned on the first primitive-based representation for the image and the second primitive-based representation for the image to generate a new image with the object at the new location. The diffusion model refers to a machine learning model that is trained to generate data, in this case the new image, via a diffusion (e.g. denoising) process.

In an embodiment, the diffusion model may be a text-to-image diffusion model. For example, the text descriptions generated for the first primitive-based representation and the second primitive-based representation may be input to the diffusion model along with the first and second primitive-based representations. The text descriptions may be used to constrain the diffusion model when generating the new image.

In an embodiment, the diffusion model may iteratively denoise the image having the object at the original location from the first primitive-based representation, and iteratively denoise the image having the object at the new location from the second primitive-based representation. In an embodiment, the diffusion model may incorporate gated self-attention masking for both iteratively denoising the image having the object at the original location and iteratively denoising the image having the object at the new location. In an embodiment, the gated self-attention masking may include, for each object in the image, converting the primitive representation for the object into a corresponding object mask and during a diffusion process, for each self-attention layer and for a projected text token associated with the object, reshaping the object mask to a spatial size of the self-attention layer and using the reshaped object mask to mask an area of self-attention between the projected text token and visual tokens.

In an embodiment, the diffusion model may further incorporate soft attention anchoring between the iteratively denoising the image having the object at the original location and the iteratively denoising the image having the object at the new location. In an embodiment, the soft attention anchoring may include extracting a first self-attention output for the object in the image having the object at the original location, extracting a second self-attention output for the object in the image having the object at the new location, in each of a first predefined number of steps of a denoising process, blending the first self-attention output and the second self-attention output in accordance with a timestep ratio to generate an interpolated self-attention output, and in each of the remaining steps of the denoising process, using the first self-attention output associated with the original location of the object to replace the second self-attention output associated with the new location of the object. In an embodiment, the appearance of the object in the image having the object at the new location may be determined using nearest-neighbor copying from the first self-attention output.

In an embodiment, when the image is a real-world image, the diffusion model may additionally, during a forward diffusion process, add independent noises with differing scales to the real-world image to form a plurality of noisy images, where the scale is a function of a time step of the forward diffusion process, and during a denoising process, obtain self-attention outputs from the plurality of noisy images.

To this end, the method 100 may be performed to relocate the object from its original location in the image to the new location in the image, with using a diffusion model that can harness spatial understanding during such relocation of the object. As a result, the method 100 may seamlessly relocate (e.g. drag) the object from its original location to the new location in the image while preserving the foreground and background features or appearance of the image. In an embodiment, the method 100 may also be repeated for relocating multiple different objects in the image.

Further embodiments will now be provided in the description of the subsequent figures. It should be noted that the embodiments disclosed herein with reference to the method 100 of FIG. 1 may apply to and/or be used in combination with any of the embodiments of the remaining figures below.

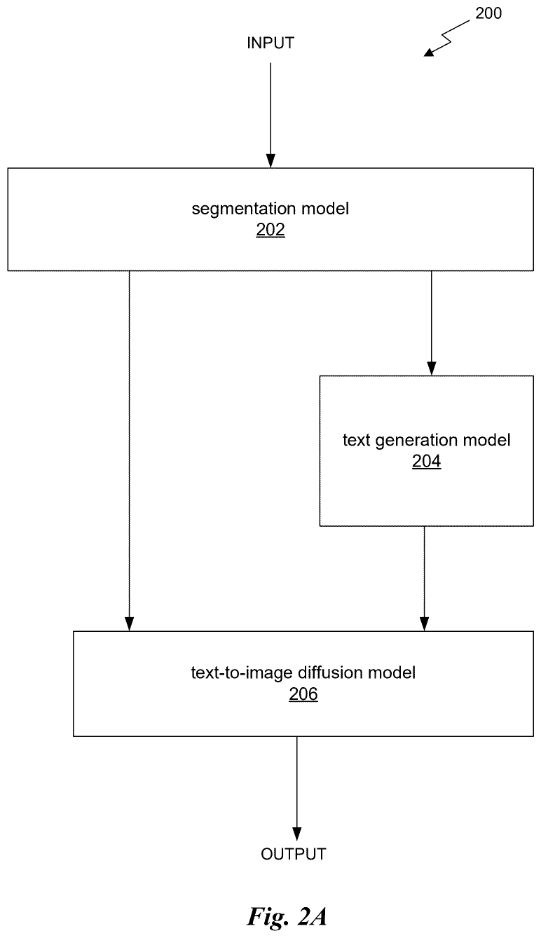

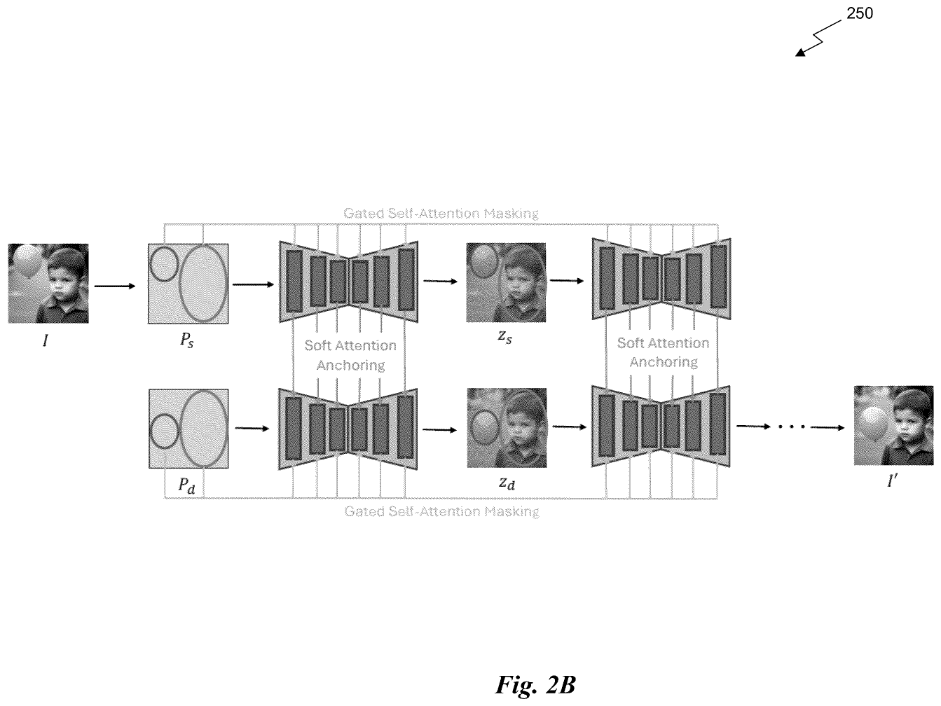

FIG. 2A illustrates a neural network architecture 200 configured to relocate an object in an image, in accordance with an embodiment. The neural network architecture 200 may be implemented to carry out the method 100 of FIG. 1, in an embodiment. Further, the descriptions and/or definitions given above may equally apply to the present embodiment.

As shown, the neural network architecture 200 includes a segmentation model 202. The segmentation model 202 is a machine learning model that has been trained to perform segmentation on an input image. The segmentation model 202 processes the image to generate a first primitive-based representation for the image. The first primitive-based representation may include the blob parameters of the layout of the image. Then, given a user provided target (new) location for an object in the image, a second primitive-based representation is generated for the image having the object at the new location. In an embodiment, the second primitive-based representation may be generated by changing the layout defined in the first primitive-based representation to reflect the object at the new location.

The neural network architecture 200 also includes a text generation model 204 that processes the first and second primitive-based representations to generate respective text descriptions for those representations. The neural network architecture 200 includes a text-to-image diffusion model 206 that processes the first and second primitive-based representations and their respective text descriptions to generate a new image having the object at the new location. The new image is provided as the output of the neural network architecture 200. The new image may be output to a display device for presentation to the user, in an embodiment.

FIG. 2B illustrates a pipeline 250 of the neural network architecture 200 of FIG. 2A, in accordance with an embodiment.

Given an input image I with an object located in (xₓ, C_{y}) that the user wants to drag, and a desired target (new) location (c′ₓ, c′_{y}), the task of object dragging aims at moving the object to the target location while the rest of the image is left intact, up to desired environment changes (e.g., reflections) in the new (edited) image I′. In the present embodiment, the input image I may be referred to as the source image and the new image I′ may be referred to as the target image.

The segmentation model 202 extracts the blob parameters Pₛ of the layout of the image I. Its layout is then changed based on the user provided target location, to get the new blob parameters P_{d}. Text descriptions of Pₛ and P_{d}are generated by the text generation model 204 (not shown).

The text-to-image diffusion model 206, constrained by the text descriptions, is then conditioned on Ps and Pato generate the new image I′. In particular, the text-to-image diffusion model 206 iteratively denoises the source and target images (zₛ and z_{d}) while incorporating gated self-attention masking and soft attention anchoring in each self-attention block, as described below, until the desired editing result I′ is obtained.

### Gated Self-Attention Masking

Given a scene depicted in image/represented with Ps which includes n blob inputs B₁, . . . . Bₙ, the parameters τₛ of one blob Bₛ are changed to τ_{d} with a different spatial location such that the s^{th} object in the generated image I′ will be relocated to the target location, without changing the appearance of all other objects and the background (barring direct interactions with the object, e.g., shadows).

To preserve the high-level object appearance, a self-attention sharing mechanism is used which iteratively generates the source image using the source parameters τₛ in parallel with iteratively generating the target image with the τ_{d} parameters. Then, the self-attention keys K_{d} and values V_{d} from the target image are replaced in each self-attention layer and each denoising step by the keys and values Kₛ,Vₛ from the source image.

In one implementation of the gated self-attention, a projection layer first converts the text embeddings of the text description Sᵢ to the text tokens T={t₁, . . . tₙ}. They are then merged with the visual tokens V={v₁, . . . . vₖ} into a unified set V∪T={v₁, . . . . vₖ, t₁, . . . tₙ}, which altogether are used to calculate the self-attention features, using a self-attention mechanism (plus a gated skip connection).

### Soft Attention Anchoring

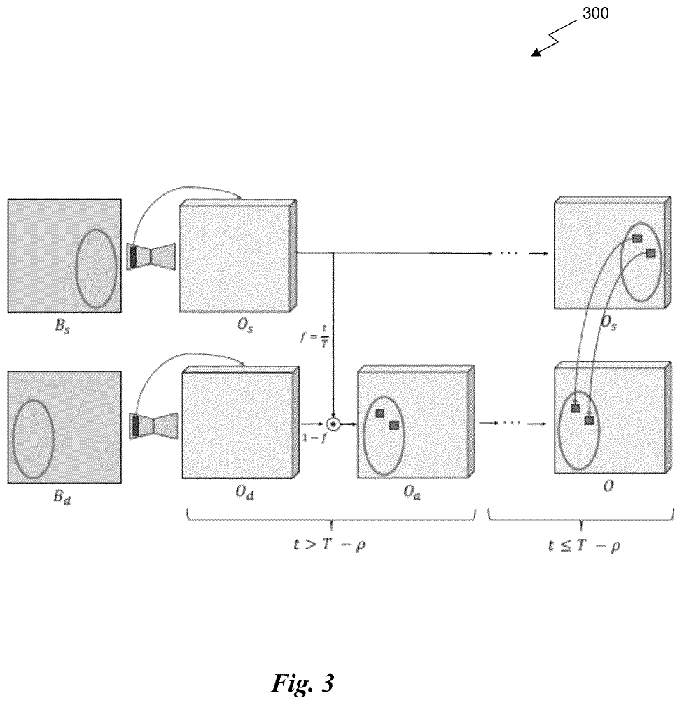

To more fully preserve the fine-grained details of the source image, a soft anchoring mechanism is used. The source image already contains the information needed for generating the target image, such that advantage can be taken of the self-attention layers output (i.e., attention features) in the local region that corresponds to the source blob. The soft anchoring is designed to fuse the object appearance information represented by the attention features within the source blob and the positional information indicated by the target blob. Specifically, in the first p steps of the denoising process, an adaptive, soft blending of the attention features of the generated target image with the features of the source image is performed. The interpolation coefficient is time-dependent, namely more visual appearance from the source image is taken in the beginning but more spatial information from the target image is taken in the later steps, as depicted in FIG. 3. Formally, for each denoising step t∈[T,T−1, . . . ,T−p+1] and for each self-attention layer, the interpolated self-attention output of the target image is computed in accordance with Equation 1.

$${O}_{a} = {O}_{s} * f + {O}_{d} * ( 1 - f ) ; f = \frac{t}{T} \qquad Equation 1$$

where Oₛ is the self-attention output of the generated source image, O_{d} is the self-attention output of the generated target image, and T is the total number of denoising steps. The length of soft blending is controlled by the hyperparameter p.

Next, during the last T−p steps of the denoising process, the soft blending result Oₐ is used as anchor points for the target object. In each denoising step t∈[T−p, . . . , 2, 1] and each self-attention layer, the nearest-neighbor copying is performed, namely each entry from the anchor attention features Oₐ within the target blob B_{d} is replaced by its nearest-neighbor entry from the source attention features Oₛ within the source blob Bₛ. The nearest-neighbor entry is obtained by measuring the normalized cosine similarity, per Equation 2.

$${( {O}_{a} )}_{{( j , k ) ∈ {B}_{d}}^{}} = {( {O}_{s} )}_{N N ( j , k ) ∈ {B}_{s}} \qquad Equation 2$$

where (j, k)∈B_{d} represents the set of coordinates for each entry from Oₐ within the target blob B_{d} and NN (j, k)∈Bₛ denotes the set of coordinates for each nearest-neighbor entry from Oₛ within the source blob Bₛ. Thus, the nearest-neighbor operation is within the source blobs Bₛ and destination blob Bboundaries, which are reshaped to the corresponding self-attention size of each layer.

### Extension for Real Images

The neural network architecture 200 of FIG. 2A can be extended for dragging objects in real images by including self-attention bucketing, which includes first adding independent noises with various scales to the real image, where the noise scale corresponds to a time step in the forward process of the text-to-image diffusion model 206. The noisy images at every time step, along with the extracted blobs, are then passed through a reverse (denoising) process of the text-to-image diffusion model 206 to get self-attention outputs in every attention layer, as needed. Note that the self-attention bucketing is specifically designed for the object dragging task, which aims to preserve the visual details of the real image.

For extracting the blobs representations from real images, the segmentation model 202 may be used to get instance segmentation maps, following by using an ellipse fitting optimization (not shown) with the goal of maximizing the Intersection Over Union (IOU) between the ellipse and the generated mask. Finally, a local region around each blob may be cropped and processed by the text generation model 204 to provide the local captioning (text descriptions).

Finally, in order to better preserve the background, a Blended Latent Diffusion process may be incorporated in which the background pixels are being integrated into the diffusion process in order to seamlessly blend the generated result in the original scene. Blended Latent Diffusion is a process designed for localized image editing using text-to-image diffusion models. The input image is fused into the diffusion process along with an input mask to preserve it background, while encouraging the generated content (in the unmasked area) to be consistent to the background. To incorporate this process into the editing of real images, given the source blob Bₛ and the destination blob B_{d}, the union blob is obtained which contains both of them Bᵤ=Bₛ∪B_{d}, and the union is morphologically dilated with a kernel (e.g. of a size of 50×50). This dilated blob is treated as the editable area, which is provided to the Blended Latent Diffusion process to edit real images during the entire diffusion process (i.e. the hyperparameter of noising diffusion steps k=T, where T is the total number of diffusion steps).

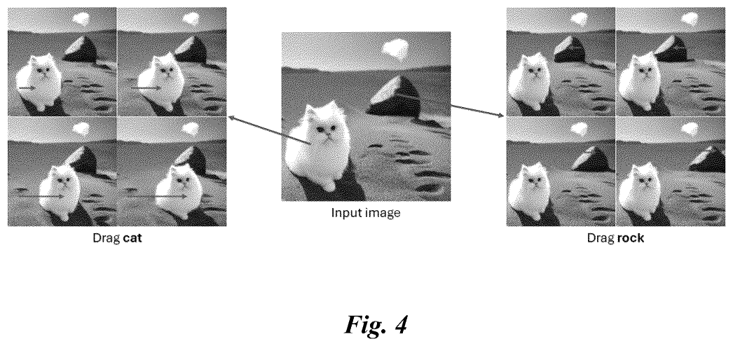

FIG. 4 illustrates an exemplary input and output of the method 100 of FIG. 1, in accordance with an embodiment.

As shown. given a real image with multiple objects (e.g., a cat and a rock), the method 100 is able to seamlessly drag each of the objects to an arbitrary (e.g. user selected) location within the image while preserving the foreground and background appearance.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

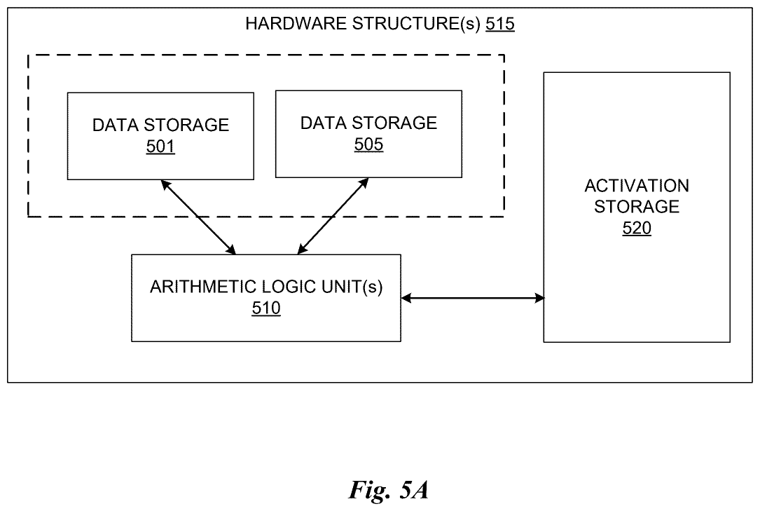

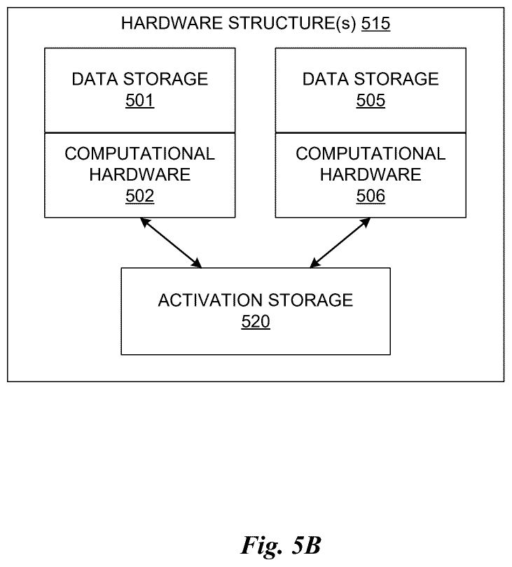

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

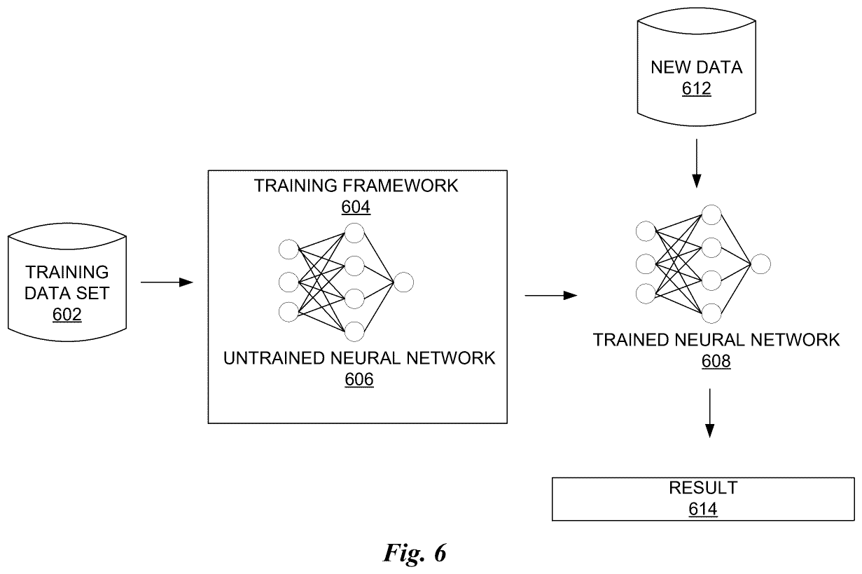

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

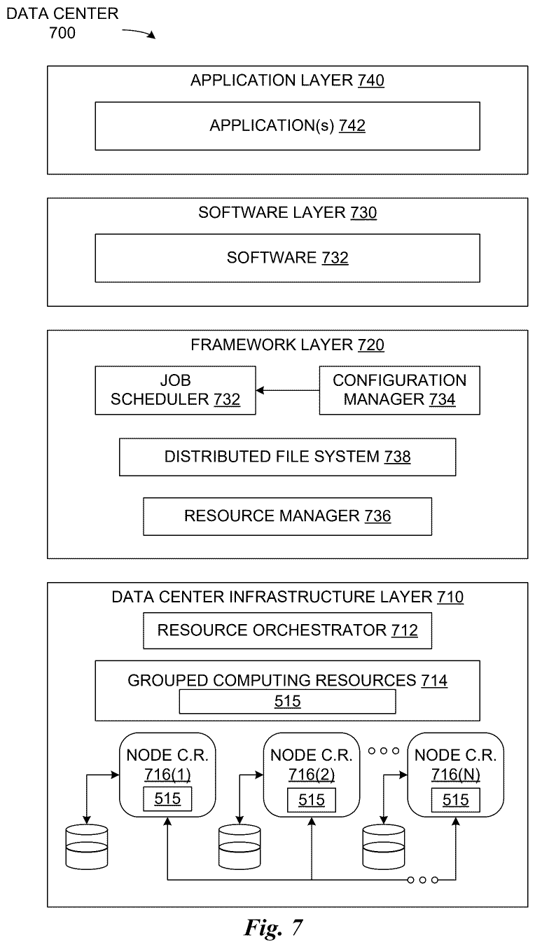

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide object relocation within an image. In accordance with FIGS. 1-4, embodiments may provide a diffusion model usable for performing inferencing operations and for providing inferenced data. The diffusion model may be stored (partially or wholly) in one or both of data storage 501 and 505 in inference and/or training logic 515 as depicted in FIGS. 5A and 5B. Training and deployment of the diffusion model may be performed as depicted in FIG. 6 and described herein. Distribution of the diffusion model may be performed using one or more servers in a data center 700 as depicted in FIG. 7 and described herein.

What is claimed is:

1. A method, comprising:
at a device:
obtaining an input specifying a relocation of an object existing in an image from an original location in the image to a new location in the image;
generating a first primitive-based representation for the image having the object at the original location and a second primitive-based representation for the image having the object at the new location; and
conditioning a diffusion model on the first primitive-based representation for the image and the second primitive-based representation for the image to generate a new image with the object at the new location.

2. The method of claim 1, wherein the input is generated by a user.

3. The method of claim 2, wherein the input is obtained by the user dragging the object existing in the image from the original location in the image to the new location in the image.

4. The method of claim 1, wherein the first primitive-based representation and the second primitive-based representation are blob representations.

5. The method of claim 1, wherein the first primitive-based representation includes a first set of parameters defining a layout of the image having the object at the original location, and wherein the second primitive-based representation includes a second set of parameters defining a layout of the image having the object at the new location.

6. The method of claim 1, wherein the first primitive-based representation and the second primitive-based representation are generated using a segmentation model.

7. The method of claim 6, wherein the segmentation model generates a segmentation map from an input image and wherein a primitive optimization is performed to find the best-fitting ellipse for the segmentation map to generate a primitive-based representation for the input image.

8. The method of claim 1, wherein the first primitive-based representation and the second primitive-based representation include respective text descriptions.

9. The method of claim 8, wherein the respective text descriptions are generated using a machine learning model.

10. The method of claim 8, wherein the machine learning model processes a cropped region surrounding an object to generate a text description for the object.

11. The method of claim 1, wherein the diffusion model is a text-to-image diffusion model.

12. The method of claim 1, wherein the diffusion model:
iteratively denoises the image having the object at the original location from the first primitive-based representation, and
iteratively denoises the image having the object at the new location from the second primitive-based representation.

13. The method of claim 12, wherein the diffusion model:
incorporates gated self-attention masking for each of iteratively denoising the image having the object at the original location and iteratively denoising the image having the object at the new location.

14. The method of claim 13, wherein the gated self-attention masking includes, for each object in the image:
converting the primitive representation for the object into a corresponding object mask,
during a diffusion process, for each self-attention layer and for a projected text token associated with the object, reshaping the object mask to a spatial size of the self-attention layer and using the reshaped object mask to mask an area of self-attention between the projected text token and visual tokens.

15. The method of claim 12, wherein the diffusion model:
incorporates soft attention anchoring between the iteratively denoising the image having the object at the original location and the iteratively denoising the image having the object at the new location.

16. The method of claim 15, wherein the soft attention anchoring includes:
extracting a first self-attention output for the object in the image having the object at the original location,
extracting a second self-attention output for the object in the image having the object at the new location,
in each of a first predefined number of steps of a denoising process, blending the first self-attention output and the second self-attention output in accordance with a timestep ratio to generate an interpolated self-attention output, and
in each of the remaining steps of the denoising process, using the first self-attention output associated with the original location of the object to replace the second self-attention output associated with the new location of the object.

17. The method of claim 16, wherein the appearance of the object in the image having the object at the new location is determined using nearest-neighbor copying from the first self-attention output.

18. The method of claim 1, wherein the image is a synthetically generated image.

19. The method of claim 1, wherein the image is a real-world image.

20. The method of claim 19, wherein the diffusion model:
during a forward diffusion process, adds independent noises with differing scales to the real-world image to form a plurality of noisy images, wherein the scale is a function of a time step of the forward diffusion process, and
during a denoising process, obtains self-attention outputs from the plurality of noisy images.

21. A system, comprising:
a non-transitory memory storage comprising instructions; and
one or more processors in communication with the memory, wherein the one or more processors execute the instructions to:
obtain an input specifying a relocation of an object existing in an image from an original location in the image to a new location in the image;
generate a first primitive-based representation for the image having the object at the original location and a second primitive-based representation for the image having the object at the new location; and
condition a diffusion model on the first primitive-based representation for the image and the second primitive-based representation for the image to generate a new image with the object at the new location.

22. The system of claim 21, wherein the input is generated by a user, and wherein the input is obtained by the user dragging the object existing in the image from the original location in the image to the new location in the image.

23. The system of claim 21, wherein the first primitive-based representation and the second primitive-based representation are blob representations.

24. The system of claim 21, wherein the first primitive-based representation and the second primitive-based representation are generated using a segmentation model.

25. The system of claim 24, wherein the segmentation model generates a segmentation map from an input image and wherein a primitive optimization is performed to find the best-fitting ellipse for the segmentation map to generate a primitive-based representation for the input image.

26. The system of claim 21, wherein the first primitive-based representation and the second primitive-based representation include respective text descriptions generated using a machine learning model.

27. The system of claim 21, wherein the diffusion model is a text-to-image diffusion model.

28. The system of claim 21, wherein the diffusion model:
iteratively denoises the image having the object at the original location from the first primitive-based representation, and
iteratively denoises the image having the object at the new location from the second primitive-based representation.

29. The system of claim 28, wherein the diffusion model:
incorporates gated self-attention masking for each of iteratively denoising the image having the object at the original location and iteratively denoising the image having the object at the new location,
wherein the gated self-attention masking includes, for each object in the image:
converting the primitive representation for the object into a corresponding object mask, and
during a diffusion process, for each self-attention layer and for a projected text token associated with the object, reshaping the object mask to a spatial size of the self-attention layer and using the reshaped object mask to mask an area of self-attention between the projected text token and visual tokens, and
incorporates soft attention anchoring between the iteratively denoising the image having the object at the original location and the iteratively denoising the image having the object at the new location,
wherein the soft attention anchoring includes:
extracting a first self-attention output for the object in the image having the object at the original location,
extracting a second self-attention output for the object in the image having the object at the new location,
in each of a first predefined number of steps of a denoising process, blending the first self-attention output and the second self-attention output in accordance with a timestep ratio to generate an interpolated self-attention output, and
in each of the remaining steps of the denoising process, using the first self-attention output associated with the original location of the object to replace the second self-attention output associated with the new location of the object.

30. A non-transitory computer-readable media storing computer instructions which when executed by one or more processors of a device cause the device to:
obtaining an input specifying a relocation of an object existing in an image from an original location in the image to a new location in the image;
generating a first primitive-based representation for the image having the object at the original location and a second primitive-based representation for the image having the object at the new location; and
conditioning a diffusion model on the first primitive-based representation for the image and the second primitive-based representation for the image to generate a new image with the object at the new location.

31. The non-transitory computer-readable media of claim 30, wherein the input is generated by a user, and wherein the input is obtained by the user dragging the object existing in the image from the original location in the image to the new location in the image.

32. The non-transitory computer-readable media of claim 30, wherein the first primitive-based representation and the second primitive-based representation are blob representations.

33. The non-transitory computer-readable media of claim 30, wherein the first primitive-based representation and the second primitive-based representation are generated using a segmentation model.

34. The non-transitory computer-readable media of claim 30, wherein the first primitive-based representation and the second primitive-based representation include respective text descriptions generated using a machine learning model.

35. The non-transitory computer-readable media of claim 30, wherein the diffusion model is a text-to-image diffusion model.

36. The non-transitory computer-readable media of claim 30, wherein the diffusion model:
iteratively denoises the image having the object at the original location from the first primitive-based representation, and
iteratively denoises the image having the object at the new location from the second primitive-based representation.

37. The non-transitory computer-readable media of claim 36, wherein the diffusion model:
incorporates gated self-attention masking for each of iteratively denoising the image having the object at the original location and iteratively denoising the image having the object at the new location,
wherein the gated self-attention masking includes, for each object in the image:
converting the primitive representation for the object into a corresponding object mask, and
during a diffusion process, for each self-attention layer and for a projected text token associated with the object, reshaping the object mask to a spatial size of the self-attention layer and using the reshaped object mask to mask an area of self-attention between the projected text token and visual tokens, and
incorporates soft attention anchoring between the iteratively denoising the image having the object at the original location and the iteratively denoising the image having the object at the new location,
wherein the soft attention anchoring includes:
extracting a first self-attention output for the object in the image having the object at the original location,
extracting a second self-attention output for the object in the image having the object at the new location,
in each of a first predefined number of steps of a denoising process, blending the first self-attention output and the second self-attention output in accordance with a timestep ratio to generate an interpolated self-attention output, and
in each of the remaining steps of the denoising process, using the first self-attention output associated with the original location of the object to replace the second self-attention output associated with the new location of the object.
